(19) United States
(12) Patent Application Publication
(10) Pub. No.: US 2026/0307160 A1
(43) Pub. Date: Oct. 8, 2026

(54) Pipe Cutting Machine

(71) Applicant: Wuyi Zhuanzhuan Industry and Trade Co., Ltd., Jinhua (CN)

(72) Inventor: Weihong Jin, Jinhua (CN)

(21) Appl. No.: 19/214,628

(22) Filed: May 21, 2025

(30) Foreign Application Priority Data
Apr. 7, 2025 (CN) 2025206392109

(51) Int. Cl. B23D 21/04

(52) U.S. Cl. CPC B23D 21/04

(57) ABSTRACT

This invention herein relates to the technical field of pipe-cutting equipment, particularly relates to the pipe cutting machine, comprising the clamping device and the pipe cutting device slidably provided on the clamping device. The clamping device comprises the first clamping component and second clamping component rotationally connected by the screw. The first clamping component and second clamping component are rotationally and respectively provided with the first clamping seat and the second clamping seat. The first clamping seat and the second clamping seat are rotationally connected by the screw, and both are provided with clamping elements for clamping the pipe. The purpose of the present invention herein is to provide the pipe cutting machine with stable structure, high cutting efficiency and long service life.

### TECHNICAL FIELD

This invention herein relates to the technical field of pipe-cutting equipment, particularly relates to the pipe cutting machine.

### BACKGROUND OF THE ART

Currently, there are no dedicated electric cutting devices for large-diameter plastic pipes commercially available. Existing solutions rely on repurposed tools from other applications, which are time-consuming, labor-intensive, and produce uneven, non-smooth cut surfaces.

### SUMMARY

The object of the present invention herein is to provide the pipe cutting machine with stable structure, smooth cutting and no burrs.

The object of the present invention is achieved in that: Pipe cutting machine herein comprises: the clamping device and the pipe cutting device slidably arranged on the clamping device; the clamping device comprises the first clamping component and the second clamping component rotatably connected by screws; the first clamping seat and second clamping seat are respectively rotatably arranged in the first clamping component and the second clamping component; the first clamping seat and the second clamping seat are rotatably connected by screws; the clamping elements for clamping pipes are provided on the first clamping seat and the second clamping seat.

Preferably, the first clamping component and the second clamping component are both provided with the elliptical channel; the first clamping seat and the second clamping seat are both formed with the extension part rotatably arranged in the elliptical channel; the extension part is provided with plurality of through holes along the circumference; the through holes are each provided with the ball; and the ball is slidably arranged in the elliptical channel.

Preferably, the first clamping seat and the second clamping seat are formed with the stop collar which abuts against one side of the first clamping component and the second clamping component; the other side of the first clamping component and the first clamping component abuts against the limit strip; the limit strip is connected to the side wall of the first clamping component and the second clamping component.

Preferably, the second clamping component and the second clamping seat are respectively provided with the first mounting rack and the second mounting rack; the first mounting rack and the second mounting rack are respectively rotatably provided with the first screw and the second screw; the first screw and the second screw are threadedly connected with the first nut and the second nut; the first nut abuts against the first mounting base formed on the first clamping component; the second nut abuts against the second mounting base formed on the second clamping component.

Preferably, the upper end and the lower end of the first clamping component are respectively formed with the clamping claw I and the clamping claw II, which respectively hold the upper end and the lower end of the second clamping component in the middle.

Preferably, the second clamping component is marked with the arrow, which matches the protrusion formed on the second clamping seat.

Preferably, the clamping elements comprise plurality of stackable clamping blocks adapted to pipes of different specifications; the clamping blocks are provided with the first annular groove; the inner wall of the first annular groove is provided with the first buckle; the first buckle is clamped with the first clamping groove formed on the outer wall of the clamping seat.

Preferably, the inner wall of the clamping blocks is provided with second annular groove which is engaged with the bent section formed on the outer wall of the first clamping block; the inner wall of the bent section is provided with the second buckle which is engaged with the second clamping groove formed on the outer wall of the second annular groove.

Preferably, the first clamping component and the second clamping component are connected via the first screw assembly; the first clamping seat and the second clamping seat (6) are connected via the second screw assembly; the screw hole of the first screw assembly and the screw hole of the second screw assembly are coaxially arranged.

Preferably, limit blocks for limiting the opening angle of the pipe cutting machine are formed below the first clamping component and the first clamping seat.

Preferably, the pipe cutting device comprises the housing and the sliding motor base formed at the bottom of the housing; sliding channels are provided on both side walls of the sliding motor base; the sliding channels are adapted to the sliding rails formed on one side of the first clamping component; the adjustment screw is abutted in the sliding groove provided at the bottom of the sliding motor base; the adjustment screw is screwed into the screw hole provided in the first clamping component; the placement section is formed at the front end of the sliding motor base for facilitating the pipe cutting device to slide into the sliding rails.

Preferably, the motor is arranged in the housing; the motor output shaft is arranged at the front end of the motor; the coupling is arranged at the front end of the motor output shaft; the cutter head is arranged at the front end of the coupling; the slot is arranged at the rear end of the coupling; the slot is engaged with the recess arranged on the side wall of the front end of the motor output shaft; the bearing is sleeved at the connection between the motor output shaft and the coupling.

Preferably, the bearing is sleeved at the connection between the motor output shaft and the coupling.

Compared with the prior art, the present invention herein has the outstanding and beneficial technical effect that the pipe cutting machine of the present invention herein utilizes the elliptical channel with balls arranged on the extension section to lock the clamping seat within the channel, enabling precise rotational adjustment of the hub along the elliptical path. The pipe cutting machine of the present invention herein utilizes the elliptical channel with balls arranged on the extension section to lock the clamping seat within the channel, enabling precise rotational adjustment of the hub along the elliptical path.

### DESCRIPTION OF THE DRAWINGS

FIG. 1 illustrates the first one of the structure schematic diagrams of the present invention herein;

FIG. 2 illustrates the second one of the structure schematic diagrams of the present invention herein;

FIG. 3 illustrates the cross-sectional view of the present invention herein;

FIG. 4 illustrates the first one of the exploded schematic diagrams of the present invention herein;

FIG. 5 illustrates the second one of the exploded schematic diagrams of the present invention herein;

FIG. 6 illustrates the exploded schematic diagram of the pipe cutting device of the present invention herein.

### DETAILED DESCRIPTION

The invention herein is further described below by way of specific embodiments.

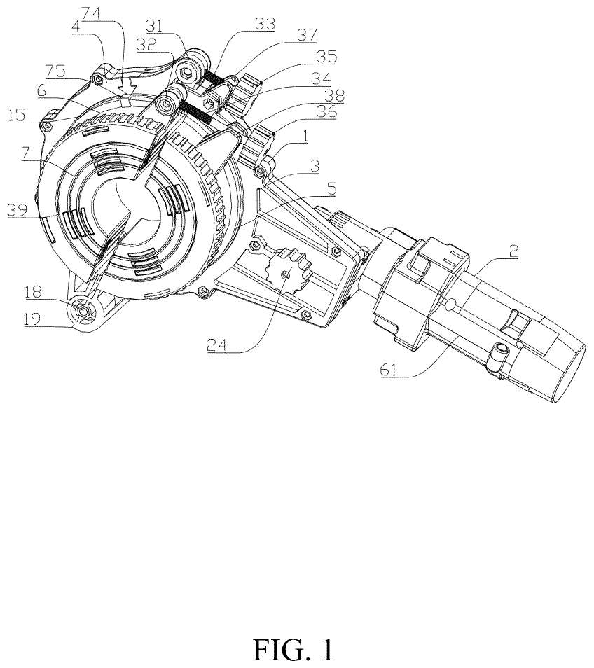

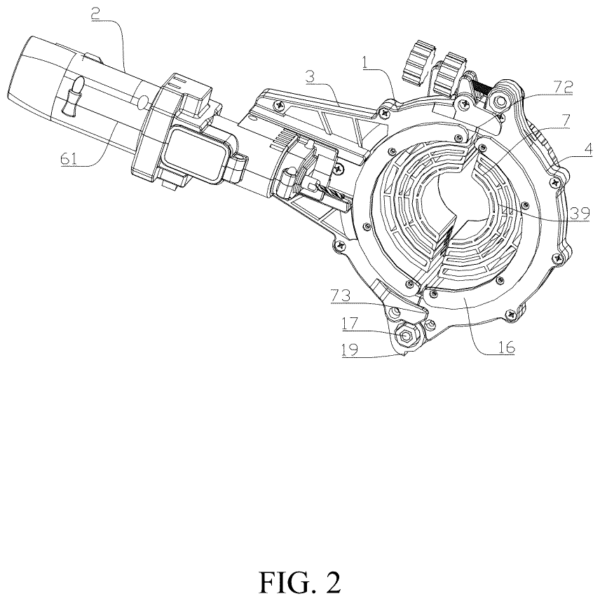

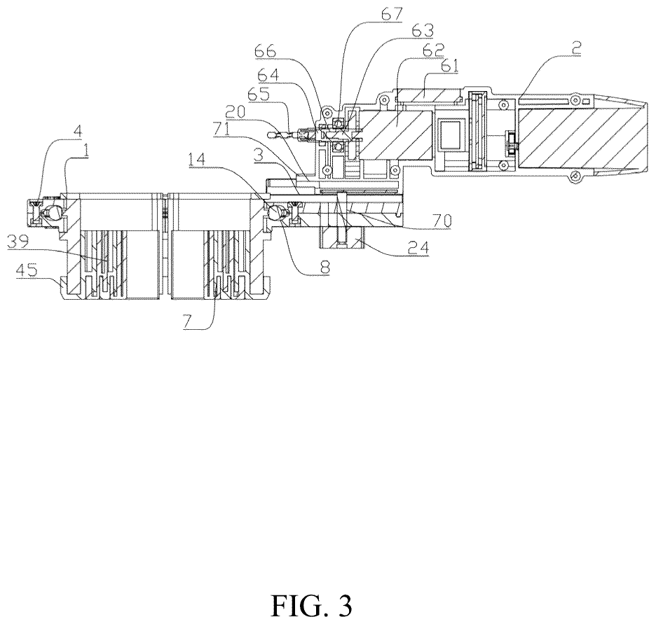

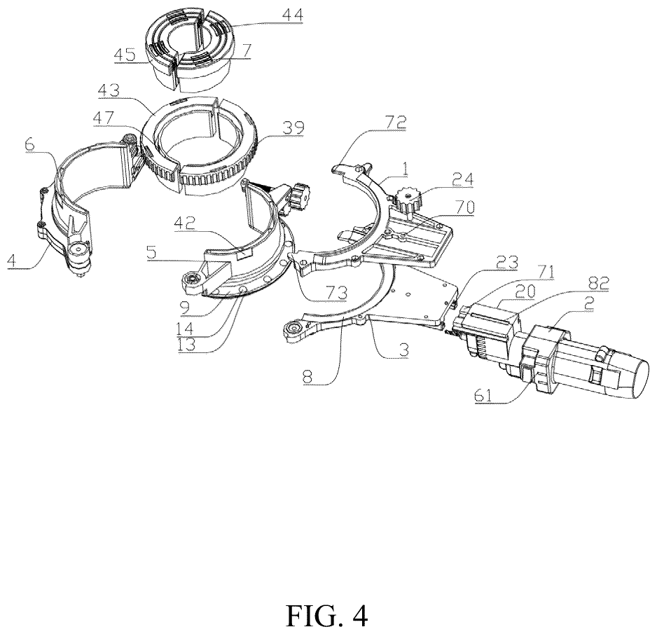

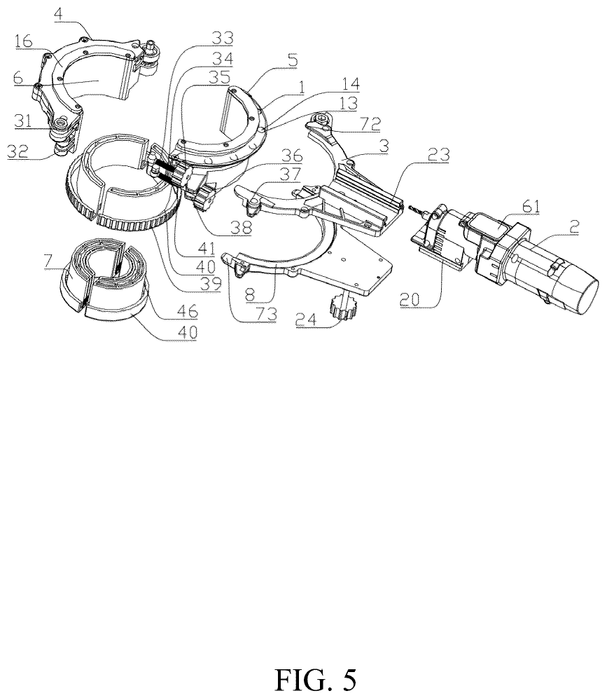

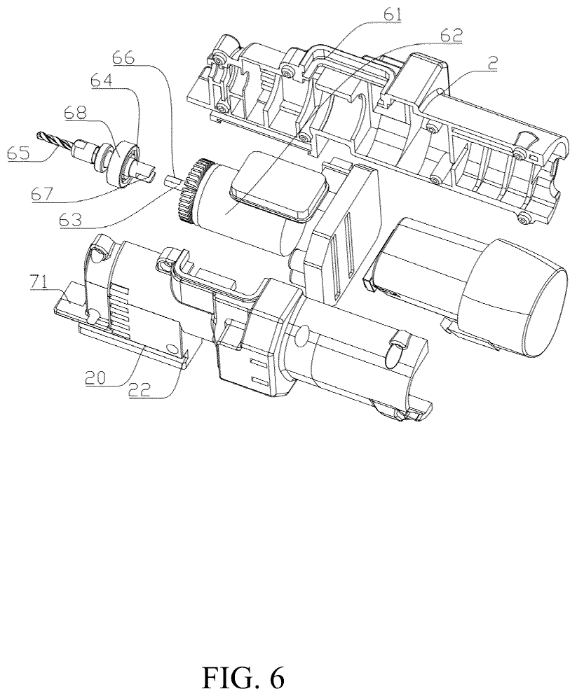

Referred to FIGS. 1-6, the pipe cutting machine herein comprises a clamping device 1 and a pipe cutting device 2 slidably arranged on the clamping device 1; the clamping device 1 comprises a first clamping component 3 and a second clamping component 4 rotatably connected by screws; a first clamping seat 5 and a second clamping seat 6 are respectively rotatably arranged in the first clamping component 3 and the second clamping component 4; the first clamping seat 5 and the second clamping seat 6 are rotatably connected by screws; clamping elements 7 for clamping pipes are provided on the first clamping seat 5 and the second clamping seat 6.

The pipe cutting machine of the present invention herein utilizes an elliptical channel 8 with balls 14 arranged on an extension section 9 to lock the clamping seats within the elliptical channel 8, enabling precise rotational adjustment of the hub along the elliptical path. The pipe cutting machine of the present invention herein utilizes the elliptical channel with balls arranged on the extension section to lock the clamping seat within the channel, enabling precise rotational adjustment of the hub along the elliptical path.

Preferably, the first clamping component 3 and the second clamping component 4 are both provided with the elliptical channel 8; the first clamping seat 5 and the second clamping seat 6 are both formed with the extension part 9 rotatably arranged in the elliptical channel 8; the extension part 9 is provided with plurality of through holes 13 along the circumference; the through holes 13 are each provided with the ball 14; and the ball 14 is slidably arranged in the elliptical channel 8. The strength and stability of the connection structure between the clamping component and the clamping seat can be increased by the extension section 9.

Preferably, the first clamping seat 5 and the second clamping seat 6 are formed with a stop collar 15 which abuts against one side of the first clamping component 3 and the second clamping component 4; the other side of the first clamping component 3 and the first clamping component 4 abuts against a limit strip 16; the limit strip 16 is connected to the side wall of the first clamping component 3 and the second clamping component 4.

Preferably, the second clamping component 4 and the second clamping seat 6 are respectively provided with a first mounting rack 31 and a second mounting rack 32; the first mounting rack 31 and the second mounting rack 32 are respectively rotatably provided with a first screw 33 and a second screw 34; the first screw 33 and the second screw 34 are threadedly connected with a first nut 35 and a second nut 36; the first nut 35 abuts against a first mounting base 37 formed on the first clamping component 3; the second nut 36 abuts against a second mounting base 38 formed on the second clamping component 4. This new open pipe cutting machine of the technical solution herein adopts screws to realize the interlocking of two clamping components and two clamping seats, so that the users can freely adjust the tightness according to the practical situation, which can be better adapted to different scenarios, and greatly increase the users' convenience and work efficiency.

Preferably, the first clamping component 3 has a first clamping jaw 72 and a second clamping jaw 73 mold at the upper end and the lower end respectively; the first clamping jaw 72 and the second clamping jaw 73 hold the upper end and the lower end of the second clamping component 4 in the middle respectively. Setting the first clamping jaw 72 and the second clamping jaw 73 to hold the upper and lower ends of the second clamping component 4; an inner wall of the first clamping jaw 72 and the second clamping jaw 73, and an inner wall of the second clamping component 4 abuts against each other, so as to be able to prevent the first clamping component 3 and the second clamping component 4 from swaying from side to side when cutting the pipe, and to increase the stability of the structure as well as the precision of the pipe cutting.

Preferably, the second clamping component 4 is marked with an arrow 74, which is adapted to a protrusion 75 molded on the second clamping seat 6. By setting the arrow 74 and the protrusion 75, the user can open the pipe cutter only when the arrow 74 and the protrusion 75 correspond to each other, increasing the opening convenience and working efficiency for the user.

Preferably, the clamping elements 7 comprise plurality of stackable clamping blocks 39 adapted to pipes of different specifications; the clamping blocks 39 are provided with a first annular groove 40; an inner wall of the first annular groove 40 is provided with a first buckle 41; the first buckle 41 is clamped with a first clamping groove 42 formed on an outer wall of the clamping seat. Connecting the clamping seat with the clamping block by means of the first buckle 41 and the first clamping groove 42 can facilitate quick disassembly by the user and easy installation and adjustment.

Preferably, an inner wall of the clamping blocks 39 is provided with a second annular groove 43 which is engaged with a bent section 45 formed on an outer wall of a first clamping block 44; an inner wall of the bent section 45 is provided with a second buckle 46 which is engaged with a second clamping groove 47 formed on an outer wall of the second annular groove 43. By providing plurality of sets of first clamping block 44 on the clamping blocks 39 can facilitate the user to lock for different specifications of the pipe and increase the work efficiency.

Preferably, the first clamping component 3 and the second clamping component 4 are connected via a first screw assembly 17; the first clamping seat 5 and the second clamping seat 6 are connected via a second screw assembly 18; a screw hole of the first screw assembly 17 and a screw hole of the second screw assembly 18 are coaxially arranged. The concentric setup increases the efficiency of cutting by smoothly opening the clamps on both sides and preventing wobbling when cutting tubes.

Preferably, a limit block 19 for limiting the opening angle of the pipe cutting machine are formed below the first clamping component 3 and the first clamping seat 5. Setting the limit block 19 can limit the opening angle of the pipe cutter, which can clamp the pipe more quickly and increase the efficiency of pipe cutting.

Preferably, the pipe cutting device 2 comprises a housing 61 and a sliding motor base 20 formed at a bottom of the housing 61; sliding channels 22 are provided on both side walls of a sliding motor base 20; the sliding channels 22 are adapted to sliding rails 23 formed on one side of the first clamping component 3; an adjustment screw 24 is abutted in a sliding groove 82 provided at a bottom of the sliding motor base 2; the adjustment screw 24 is screwed into a screw hole 70 provided in the first clamping component 3; a placement section 71 is formed at the front end of the sliding motor base 20 for facilitating the pipe cutting device 2 to slide into the sliding rails 23. The adjustment screw 24 can be set to adjust the sliding distance of the sliding motor base 20 according to the pipes with different wall thicknesses. The adjustment screw 24 is set in the sliding groove 82 to ensure that the pipe cutting device 2 will not fall during operation. After the adjustment screw 24 is locked, it abuts against the surface of the sliding groove 82 to lock the sliding motor base20, preventing it from sliding, thereby increasing the stability of the structure.

Preferably, a motor 62 is arranged in the housing 61; a motor output shaft 63 is arranged at the front end of the motor 62; a coupling 64 is arranged at a front end of the motor output shaft 63; a cutter head 65 is arranged at a front end of the coupling 64; a slot 66 is arranged at a rear end of the coupling 64; the slot 66 is engaged with a recess 67 arranged on the side wall of a front end of the motor output shaft 63.

Preferably, a bearing 68 is sleeved at the connection between the motor output shaft 63 and the coupling 64.

Working principle: When the pipe cutting machine of the present invention herein cuts the pipe, first place the plastic pipe to be cut on the auxiliary equipment that can facilitate the cutting, and rotate the clamping so that the position of the arrow 74 and the protrusion 75 both correspond to each other; unscrew the first nut 35 and the second nut 36; open the clamping device 1 to fasten on the pipe, and micro-tighten the first nut 35 and the second nut 36, to realize the holding tight on the pipe. Push the pipe cutting device 2 into the sliding channel 22 and push forward to align the cut pipe part. After adjusting the position, tighten the first nut 35 and the second nut 36 again to confirm that the clamping device 1 holds the pipe tightly, and then the pipe cutting device 2 turns on the motor 62, pushes the cutter head 65 in the direction of the pipe, and penetrates the pipe, and then cutting can be done by circling the pipe.

The above embodiments are only better embodiments of the present invention herein, and are not intended to limit the scope of protection of the present invention, therefore: any equivalent changes made in accordance with the structure, shape, and principles of the present invention herein shall be covered by the scope of protection of the present invention.

1. A pipe cutting machine, characterized in that it comprises: a clamping device (1) and a pipe cutting device (2) slidably arranged on the clamping device (1);
the clamping device (1) comprises a first clamping component (3) and a second clamping component (4) rotatably connected by screws; a first clamping seat (5) and a second clamping seat (6) are respectively rotatably arranged in the first clamping component (3) and the second clamping component (4);
the first clamping seat (5) and the second clamping seat (6) are rotatably connected by screws;
clamping elements (7) for clamping pipes are provided on the first clamping seat (5) and the second clamping seat (6).

2. The pipe cutting machine of claim 1, characterized in that, the first clamping component (3) and the second clamping component (4) are both provided with an elliptical channel (8);
the first clamping seat (5) and the second clamping seat (6) are both formed with an extension part (9) rotatably arranged in the elliptical channel (8);
the extension part (9) is provided with plurality of through holes (13) along its circumference; the through holes (13) are each provided with a ball (14); and the ball (14) is slidably arranged in the elliptical channel (8).

3. The pipe cutting machine of claim 2, characterized in that the first clamping seat (5) and the second clamping seat (6) are formed with a stop collar (15) which abuts against one side of the first clamping component (3) and the second clamping component (4);
the other side of the first clamping component (3) and the first clamping component (4) abuts against a limit strip (16); the limit strip (16) is connected to a side wall of the first clamping component (3) and the second clamping component (4).

4. The pipe cutting machine of claim 3, characterized in that the second clamping component (4) and the second clamping seat (6) are respectively provided with a first mounting rack (31) and a second mounting rack (32);
the first mounting rack (31) and the second mounting rack (32) are respectively rotatably provided with a first screw (33) and a second screw (34); the first screw (33) and the second screw (34) are threadedly connected with a first nut (35) and a second nut (36); the first nut (35) abuts against a first mounting base (37) formed on the first clamping component (3); the second nut (36) abuts against a second mounting base (38) formed on the second clamping component (4).

5. The pipe cutting machine of claim 1, characterized in that the clamping elements (7) comprise plurality of stackable clamping blocks (39) adapted to pipes of different specifications; the clamping blocks (39) are provided with a first annular groove (40); an inner wall of the first annular groove (40) is provided with a first buckle (41); the first buckle (41) is clamped with a first clamping groove (42) formed on an outer wall of the clamping seat (5, 6).

6. The pipe cutting machine of claim 5, characterized in that an inner wall of the clamping blocks (39) is provided with a second annular groove (43) which is engaged with a bent section (45) formed on the outer wall of a first clamping block (44); an inner wall of the bent section (45) is provided with a second buckle (46) which is engaged with a second clamping groove (47) formed on an outer wall of the second annular groove (43).

7. The pipe cutting machine of claim 1, characterized in that the first clamping component (3) and the second clamping component (4) are connected via a first screw assembly (17); the first clamping seat (5) and the second clamping seat (6) are connected via a second screw assembly (18); a screw hole of the first screw assembly (17) and a screw hole of the second screw assembly (18) are coaxially arranged.

8. The pipe cutting machine of claim 7, characterized in that limit blocks (19) for limiting an opening angle of the pipe cutting machine are formed below the first clamping component (3) and the first clamping seat (5).

9. The pipe cutting machine of claim 1, characterized in that the pipe cutting device (2) comprises a housing (61) and a sliding motor base (20) formed at a bottom of the housing (61); sliding channels (22) are provided on both side walls of the sliding motor base (20); the sliding channels (22) are adapted to sliding rails (23) formed on one side of the first clamping component (3); the adjustment screw (24) is abutted in a sliding groove (82) provided at a bottom of the sliding motor base (20); the adjustment screw (24) is screwed into a screw hole (70) provided in the first clamping component (3); a placement section (71) is formed at a front end of the sliding motor base (20) for facilitating the pipe cutting device (2) to slide into the sliding rails (23).

10. The pipe cutting machine of claim 9, characterized in that a motor (62) is arranged in the housing (61); a motor output shaft (63) is arranged at a front end of the motor (62); a coupling (64) is arranged at a front end of the motor output shaft (63); a cutter head (65) is arranged at a front end of the coupling (64); a slot (66) is arranged at a rear end of the coupling (64); a slot (66) is engaged with the recess (67) arranged on a side wall of the front end of the motor output shaft (63); a bearing (68) is sleeved at the connection between the motor output shaft (63) and the coupling (64).
